(19) United States
(12) Patent Application Publication
(10) Pub. No.: US 2014/0227435 A1
(43) Pub. Date: Aug. 14, 2014

(54) Method Of Protecting Transparent Nonmetallic Electroconductive Parts

(71) Applicant: Dow Corning Toray Co., Ltd., Tokyo (JP)

(72) Inventors: Katsuya Baba, Ichihara-shi (JP); Masayuki Onishi, Ichihara-shi (JP)

(73) Assignee: Dow Corning Toray Co., Ltd., Tokyo (JP)

(21) Appl. No.: 14/117,503

(22) PCT Filed: May 11, 2012
(86) PCT No.: PCT/JP2012/062734

§ 371 Date: Apr. 9, 2014

(30) Foreign Application Priority Data
May 13, 2011 (JP) 2011-107848

(51) Int. Cl. H01B 13/22

(52) U.S. Cl. CPC H01B 13/228
USPC 427/108

(57) ABSTRACT

A method of protecting a transparent nonmetallic electroconductive part formed by, e.g., ITO, on a transparent substrate, e.g., a glass substrate, from electrochemical corrosion, is characterized by coating the transparent nonmetallic electroconductive part with a room-temperature-curable silicone rubber composition that contains from 1 weight-ppm to 30 weight % of a triazole compound, e.g., a 1,2,4-triazole compound or a benzotriazole compound; and thereafter curing the composition.

### TECHNICAL FIELD

The present invention relates to a method of protecting a transparent nonmetallic electroconductive part formed of, e.g., indium tin oxide (ITO), from electrochemical corrosion.

Priority is claimed on Japanese Patent Application No. 2011-107848, filed on May 13, 2011, the content of which is incorporated herein by reference.

Glass substrates that have a transparent nonmetallic electroconductive part, e.g., an electrode or electric circuit, formed of, e.g., ITO, are used in light-receiving display devices such as liquid-crystal displays (LCDs) and electrochromic displays (ECDs) and in light-emitting display devices such as electroluminescent displays (ELDs). The transparent nonmetallic electroconductive part formed of, e.g., ITO, is generally prone to undergo electrochemical corrosion due to, e.g., condensation, salts, and so forth, in high-humidity environments, environments where a severe temperature variation occurs, and environments in which a salt fraction is suspended, which readily results in the occurrence of an increase in electrical resistance or the occurrence of interconnect scission or in the generation of appearance defects.

This has resulted in the appearance of a method in which the transparent nonmetallic electroconductive part is packed with a methacrylate-type or silicone-type molding agent that has a moisture absorption of 0.1 to 5.0% (refer to Japanese Unexamined Patent Application Publication (hereinafter referred to as “Kokai”) H05-019280) and a method in which the transparent nonmetallic electroconductive part is covered with a corrosion-preventing paint that contains a film-forming agent and an ion-exchange material (refer to Kokai H11-286628). However, even with these methods the problem arises that the electrochemical corrosion of the transparent nonmetallic electroconductive part cannot be satisfactorily inhibited.

In order, on the other hand, to inhibit the corrosion of a metal electroconductive part by corrosive gases present in the atmosphere, e.g., hydrogen sulfide gas or sulfuric acid gas, methods are known in which the metal electroconductive part is coated with a room-temperature-curable silicone rubber composition that contains 1,2,4-triazole or benzotriazole or a derivative of the preceding and this composition is then cured (refer to Kokai 2004-149611 and 2006-206817). However, these documents do not disclose the protection of a transparent nonmetallic electroconductive part formed of, e.g., ITO, from electrochemical corrosion.

It is an object of the present invention to provide a method of protecting a transparent nonmetallic electroconductive part formed of, e.g., ITO, from electrochemical corrosion.

### DISCLOSURE OF INVENTION

The method of the present invention for protecting a transparent nonmetallic electroconductive part is characterized by coating the transparent nonmetallic electroconductive part with a room-temperature-curable silicone rubber composition that contains from 1 weight-ppm to 30 weight % of a triazole compound and thereafter curing this composition.

### EFFECTS OF INVENTION

The method of the present invention for protecting a transparent nonmetallic electroconductive part can substantially inhibit electrochemical corrosion due to condensation and salts.

### BRIEF DESCRIPTION OF THE DRAWINGS

FIG. 1 is a top view of a test specimen for electrochemical corrosion testing, which was fabricated by coating a room-temperature-curable silicone rubber composition on the surface of a glass substrate having a comb-shaped ITO electrode and subsequently curing.

### REFERENCE NUMERALS USED IN THE DESCRIPTION

1 glass substrate on which comb-shaped ITO electrodes have been formed

2 cured product from a room-temperature-curable silicone rubber composition

### DETAILED DESCRIPTION OF THE INVENTION

The method of the present invention for protecting a transparent nonmetallic electroconductive part is described in detail herebelow.

The method of the present invention inhibits the electrochemical corrosion of a transparent nonmetallic electroconductive part by coating the electroconductive part with a room-temperature-curable silicone rubber composition and then curing the composition.

This transparent nonmetallic electroconductive part is formed of a nonmetal, i.e., a metal oxide, such as indium tin oxide (ITO), antimony-doped tin oxide (ATO), zinc oxide (ZnO), and so forth. Such nonmetallic electroconductive parts are formed as electrical circuits or electrodes on a transparent substrate, e.g., a glass substrate. Transparent substrates bearing such a transparent nonmetallic electroconductive part are used in, for example, light-receiving display devices such as LCDs and ECDs and light-emitting display devices such as ELDs.

A triazole compound is characteristically present in the method of the present invention in the room-temperature-curable silicone rubber composition used to protect the transparent nonmetallic electroconductive part. This triazole compound can be exemplified by 1,2,4-triazole compounds such as 1,2,4-triazole, 1-methyl-1,2,4-triazole, 1,3-diphenyl-1,2,4-triazole, 5-amino-3-methyl-1,2,4-triazole, 3-mercapto-1,2,4-triazole, 1,2,4-triazole-3-carboxylic acid, 1-phenyl-1,2,4-triazol-5-one, and 1-phenylurazole, and by benzotriazole compounds such as benzotriazole, tolyltriazole, carboxybenzotriazole, carboxybenzotriazole butyl ester, and chlorobenzotriazole, with benzotriazole compounds being preferred. A combination of two or more of these triazole compounds may be used in the method of the present invention. The content of the triazole compound is an amount that provides from 1 weight-ppm to 30 weigh t% in the room-temperature-curable silicone rubber composition and preferably is an amount that provides from 10 weight-ppm to 1 weight % in the room-temperature-curable silicone rubber composition. The reasons for this are as follows: the electrochemical corrosion of the transparent nonmetallic electroconductive part cannot be satisfactorily inhibited when the triazole compound content is below the lower limit on the above-indicated range; the physical properties of the resulting cured product decline when the upper limit on the above-indicated range is exceeded.

The room-temperature-curable silicone rubber composition can be exemplified by a room-temperature-curable silicone rubber composition that cures by an alcohol-eliminating condensation reaction, a room-temperature-curable silicone rubber composition that cures by an acetone-eliminating condensation reaction, and a room-temperature-curable silicone rubber composition that cures by a hydrogen-eliminating condensation reaction, wherein a room-temperature-curable silicone rubber composition that cures by an alcohol-eliminating condensation reaction is preferred. Such a room-temperature-curable silicone rubber composition that cures by an alcohol-liberating condensation reaction preferably comprises at least:
(A) 100 weight parts of an organopolysiloxane that has a viscosity at 25° C. of 20 to 1,000,000 mPa·s and that has in each molecule at least two silicon-bonded hydroxyl groups or silicon-bonded alkoxy groups;
(B) 0.5 to 15 weight parts of an alkoxysilane represented by the following general formula or the partial hydrolysis and condensation product of such an alkoxysilane

R¹ₐSi(OR²)₍₄₋ₐ₎

wherein R¹ is an unsubstituted or halogen-substituted monovalent hydrocarbyl group,

R² is an alkyl group, and a is an integer from 0 to 2;
(C) a triazole compound at from 1 weight-ppm to 30 weight % in the present composition; and
(D) 0.1 to 10 weight parts of a condensation reaction catalyst.

Component (A) is the base component of this composition and is an organopolysiloxane that has in each molecule at least two silicon-bonded hydroxyl groups or silicon-bonded alkoxy groups. The resulting composition does not undergo a satisfactory cure when each molecule contains fewer than two silicon-bonded hydroxyl groups or silicon-bonded alkoxy groups. This alkoxy group can be exemplified by methoxy, ethoxy, and propoxy. This alkoxy group may be directly bonded to a silicon atom in the molecular chain or may be the alkoxy group in an alkoxysilalkyl group that is itself bonded to a silicon atom in the molecular chain, wherein such an alkoxysilalkyl group can be exemplified by trimethoxysilylethyl, methyldimethoxysilylethyl, triethoxysilylethyl, and trimethoxysilylpropyl. The other silicon-bonded groups in component (A) can be exemplified by unsubstituted monovalent hydrocarbyl groups and halogen-substituted monovalent hydrocarbyl groups, e.g., alkyl groups such as methyl, ethyl, propyl, butyl, and octyl; alkenyl groups such as vinyl and allyl; aryl groups such as phenyl and tolyl; aralkyl groups such as benzyl and phenethyl; halogen-substituted alkyl groups such as 3,3,3-trifluoropropyl and 3-chloropropyl; and halogen-substituted aryl groups such as chlorobenzyl. There are no limitations on the molecular structure of component (A), and component (A) can have, for example, a straight-chain, partially branched straight-chain, branched-chain, or dendritic molecular structure, wherein straight chain and partially branched straight chain are preferred. The viscosity of component (A) at 25° C. is in the range from 20 to 1,000,000 mPa·s and preferably is in the range from 100 to 100,000 mPa·s. The reasons for this are as follows: the strength of the resulting cured product exhibits a declining trend when the viscosity of component (A) is less than the lower limit on the above-indicated range; the handling characteristics and the coatability exhibit declining trends when the upper limit on the previously indicated range is exceeded.

Component (A) can be exemplified by a dimethylpolysiloxane endblocked by the hydroxy group at both molecular chain terminals, a dimethylsiloxane.methylvinylsiloxane copolymer endblocked by the hydroxy group at both molecular chain terminals, a dimethylsiloxane.methylphenylsiloxane copolymer endblocked by the hydroxy group at both molecular chain terminals, a dimethylsiloxane.methyl(3,3,3-trifluoropropyl)siloxane copolymer endblocked by the hydroxy group at both molecular chain terminals, a dimethylpolysiloxane endblocked by the trimethoxysiloxy group at both molecular chain terminals, a dimethylsiloxane.methylvinylsiloxane copolymer endblocked by the trimethoxysiloxy group at both molecular chain terminals, a dimethylsiloxane.methylphenylsiloxane copolymer endblocked by the trimethoxysiloxy group at both molecular chain terminals, a dimethylsiloxane.methyl(3,3,3-trifluoropropyl)siloxane copolymer endblocked by the trimethoxysiloxy group at both molecular chain terminals, a dimethylpolysiloxane endblocked by the trimethoxysilylethyldimethylsiloxy group at both molecular chain terminals, a dimethylsiloxane.methylvinylsiloxane copolymer endblocked by the trimethoxysilylethyldimethylsiloxy group at both molecular chain terminals, a dimethylsiloxane.methylphenylsiloxane copolymer endblocked by the trimethoxysilylethyldimethylsiloxy group at both molecular chain terminals, a dimethylsiloxane.methyl(3,3,3-trifluoropropyl)siloxane copolymer endblocked by the trimethoxysilylethyldimethylsiloxy group at both molecular chain terminals, and mixtures of two or more of the preceding.

Component (B) is a curing agent for the present composition and is an alkoxysilane represented by the following general formula or the partial hydrolysis and condensation product of such an alkoxysilane.

R¹ₐSi(OR²)₍₄₋ₐ₎

R¹ in the preceding formula is an unsubstituted monovalent hydrocarbyl group or a halogen-substituted monovalent hydrocarbyl group and can be exemplified by alkyl groups such as methyl, ethyl, propyl, butyl, and octyl; alkenyl groups such as vinyl and allyl; aryl groups such as phenyl and tolyl; aralkyl groups such as benzyl and phenethyl; halogen-substituted alkyl groups such as 3,3,3-trifluoropropyl and 3-chloropropyl; and halogen-substituted aryl groups such as chlorobenzyl. R² in the preceding formula is an alkyl group and can be exemplified by methyl, ethyl, propyl, butyl, and octyl. a in the preceding formula is an integer from 0 to 2.

Component (B) can be exemplified by tetrafunctional alkoxysilanes such as tetramethoxysilane, tetraethoxysilane, and methyl cellosolve orthosilicate; trifunctional alkoxysilanes such as methyltrimethoxysilane, methyltriethoxysilane, ethyltrimethoxysilane, vinyltrimethoxysilane, and phenyltrimethoxysilane; difunctional alkoxysilanes such as dimethyldimethoxysilane, dimethyldiethoxysilane, diethyldimethoxysilane, divinyldimethoxysilane, and diphenyldimethoxysilane; and the partial hydrolysis and condensation products of these alkoxysilanes. The composition under consideration may also use a mixture of two or more of the preceding as component (B).

The content of component (B) is in the range from 0.5 to 15 weight parts per 100 weight parts of component (A). When component (A) contains the silicon-bonded hydroxyl group, the content of component (B) is preferably an amount whereby the number of moles of alkoxy groups in component (B) exceeds the number of moles of silicon-bonded hydroxyl groups in component (A). When component (A) contains silicon-bonded alkoxy, the content of component (B) is preferably in the range from 2 to 15 weight parts per 100 weight parts of component (A).

Component (C) is a triazole compound, and is the characteristic component for inhibiting electrochemical corrosion of the transparent nonmetallic electroconductive part. Component (C) can be exemplified by the same compounds as provided above.

The content of component (C) is an amount that provides from 1 weight-ppm to 30 weight % in the composition under consideration and preferably is an amount that provides from 10 weight-ppm to 1 weight % in the composition under consideration. The reasons for this are as follows: electrochemical corrosion of the transparent nonmetallic electroconductive part cannot be satisfactorily inhibited when the content of component (C) is below the lower limit on the above-indicated range, while the physical properties of the resulting cured product are reduced when the upper limit on the above-indicated range is exceeded.

Component (D) is a condensation reaction catalyst that accelerates the crosslinking of the present composition. Component (D) can be exemplified by tin compounds such as dimethyltin dineodecanoate and stannous octoate and by titanium compounds such as tetra(isopropoxy)titanium, tetra(n-butoxy)titanium, tetra(t-butoxy)titanium, di(isopropoxy)bis(ethyl acetoacetate)titanium, di(isopropoxy)bis(methyl acetoacetate)titanium, and di(isopropoxy)bis(acetylacetonate)titanium, and titanium compounds are particularly preferred.

The content of component (D) is in the range from 0.1 to 10 weight parts per 100 weight parts of component (A) and is preferably in the range from 0.3 to 6 weight parts per 100 weight parts of component (A). The reasons for this are as follows: curing of the resulting composition is not accelerated when the content of component (D) is less than the lower limit on the above-indicated range, while the storage stability of the resulting composition is impaired when the upper limit on the above-indicated range is exceeded.

As other, optional components, the composition under consideration may contain—insofar as the objects of the present invention are not impaired—an inorganic filler such as fumed silica, precipitated silica, calcined silica, finely divided quartz powder, calcium carbonate, fumed titanium dioxide, diatomaceous earth, aluminum hydroxide, finely divided alumina powder, magnesia, zinc oxide, zinc carbonate, a finely divided metal powder, and so forth; a filler as provided by subjecting a filler as described in the preceding to a surface treatment with, e.g., a silane, a silazane, a siloxane having a low degree of polymerization, or an organic compound; an adhesion promoter such as a silatrane derivative or a carbasilatrane derivative; as well as an antimold, a flame retardant, a heat stabilizer, a plasticizer, an agent that imparts thixotropy, a pigment, and so forth.

There are no limitations on the method of producing the composition under consideration, but this composition must be produced while excluding moisture since it cures under the effect of moisture. This composition can be stored under the exclusion of moisture as a single-package product and can also be executed as a two-package product. The composition under consideration is cured under the effect of atmospheric moisture with the formation of a cured product.

The room-temperature-curable silicone rubber composition is coated on a transparent nonmetallic electroconductive part in the method of the present invention. The transparent nonmetallic electroconductive part may optionally be cleaned prior to the application of this composition. There is no limitation on the method of applying this composition, and the application method can be exemplified by coating using a dispenser, coating using a scraper, and coating with a brush. There is no limitation in the production method of the present invention on the thickness of the room-temperature-curable silicone rubber composition coated on the transparent nonmetallic electroconductive part, but this thickness is preferably in the range from 100 pm to 5 mm. The reasons for this are as follows: the resulting cured product may not be able to satisfactorily inhibit electrochemical corrosion of the transparent nonmetallic electroconductive part when the thickness of the room-temperature-curable silicone rubber composition coated on the transparent nonmetallic electroconductive part is less than the above-indicated lower limit, while the inhibition of the electrochemical corrosion of a transparent nonmetallic electroconductive part exposed to moisture is not significantly improved above the upper limit on the previously indicated range. The room-temperature-curable silicone rubber composition is then cured in the method of the present invention. There are no limitations on the curing conditions, and this composition, since it cures at room temperature, is well adapted for those instances in which it is desired to avoid the heating of an electrical electronic device. The cure of this composition is of course accelerated by the application of heat, but heating to not more than 60° C. is recommended since overly high temperatures can result in the production of bubbles and creasing of the surface. Standing for from several minutes to about 1 week is preferred when this composition is to be cured at room temperature.

### EXAMPLES

The method of the present invention for protecting transparent nonmetallic electroconductive parts will be described in detail using examples. The viscosity reported in the examples is the value at 25° C. Electrochemical corrosion testing of the transparent nonmetallic electroconductive part was performed as follows.

### [Electrochemical Corrosion Testing of the Transparent Nonmetallic Electroconductive Part]

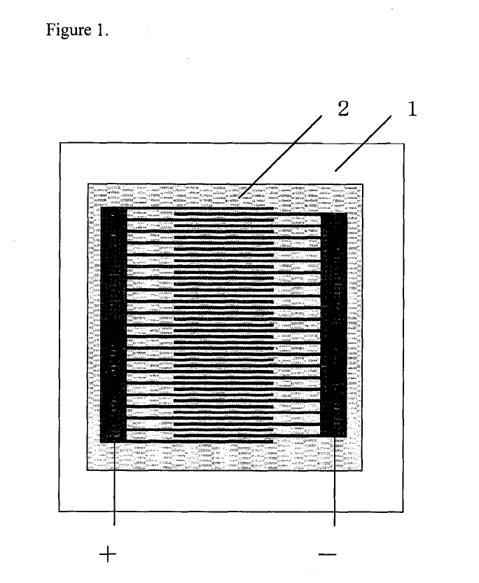

A test specimen was fabricated by coating the room-temperature-curable silicone rubber composition to a thickness of 0.6 mm on a glass substrate on which, as shown in FIG. 1, comb-shaped electrodes had been formed using a gap of 10 μm between the ITO electroconductive regions, and by then standing for 1 week at 25° C./50% RH to bring about curing. This test specimen was thereafter held for 96 hours at 60° C./95% RH while applying a voltage of 20 V between the electrodes of the test specimen. After the test, the state of the transparent nonmetallic electroconductive regions was examined with a microscope and the percentage taken up by the corroded transparent nonmetallic electroconductive area was determined (surface area with reference to the starting transparent nonmetallic electroconductive area).

### Practical Example 1

While operating under the exclusion of moisture, a room-temperature-curable silicone rubber composition that cured by an alcohol-eliminating condensation reaction was producing by mixing: 86 weight parts of a dimethylpolysiloxane endblocked by the trimethoxysiloxy group at both molecular chain terminals and having a viscosity of 3,000 mPa·s, 9 weight parts of a fumed silica having a BET specific surface area of 200 m²/g, 4 weight parts of dimethyldimethoxysilane, 0.1 weight parts of benzotriazole, and 1 weight part of diisopropoxybis(ethyl acetoacetate)titanium. A test specimen as described above was fabricated using this composition. The above-described electrochemical corrosion testing of a transparent nonmetallic electroconductive part was performed using this test specimen. The results are given in Table 1.

### Practical Example 2

A room-temperature-curable silicone rubber composition that cured by an alcohol-eliminating condensation reaction was prepared proceeding as in Practical Example 1, with the exception that the amount of benzotriazole addition used in Practical Example 1 was changed to 0.01 weight parts. A test specimen as described above was fabricated using this composition. The above-described electrochemical corrosion testing of a transparent nonmetallic electroconductive part was performed using this test specimen. The results are given in Table 1.

### Practical Example 3

A room-temperature-curable silicone rubber composition that cured by an alcohol-eliminating condensation reaction was prepared proceeding as in Practical Example 1, with the exception that the benzotriazole used in Practical Example 1 was changed to tolyltriazole. A test specimen as described above was fabricated using this composition. The above-described electrochemical corrosion testing of a transparent nonmetallic electroconductive part was performed using this test specimen. The results are given in Table 1.

### Comparative Example 1

A room-temperature-curable silicone rubber composition that cured by an alcohol-eliminating condensation reaction was prepared proceeding as in Practical Example 1, with the exception that the benzotriazole used in Practical Example 1 was not added. A test specimen as described above was fabricated using this composition. The above-described electrochemical corrosion testing of a transparent nonmetallic electroconductive part was performed using this test specimen. The results are given in Table 1.

TABLE 1

| | classification | | | |
|---|---|---|---|---|
| | | | | Comparative |
| | Present Invention | | | Example |
| | Practical | Practical | Practical | Comparative |
| item | Example 1 | Example 2 | Example 3 | Example 1 |
| electro- | slight | slight | slight | electro- |
| chemical | electro- | electro- | electro- | chemical |
| corrosion | chemical | chemical | chemical | corrosion |
| status | corrosion | corrosion | corrosion | over the |
| | at the end | at the end | at the end | entire |
| | region of | region of | region of | anode |
| | the anode | the anode | the anode | |
| percentage | <5% | <5% | <5% | 40% |
| electro- | | | | |
| chemical | | | | |
| corrosion | | | | |

### INDUSTRIAL APPLICABILITY

The method of the present invention for protecting a transparent nonmetallic electroconductive part is well adapted for use as a moistureproof sealing method for light-receiving display devices, e.g., LCDs and ECDs, that use a transparent substrate, e.g., a glass substrate, that has a transparent nonmetallic electroconductive part and for use as a moistureproof sealing method for light-emitting display devices, e.g., ELDs, that use a transparent substrate, e.g., a glass substrate, that has a transparent nonmetallic electroconductive part.

1. A method of protecting a transparent nonmetallic electroconductive part, the method comprising:
coating the transparent nonmetallic electroconductive part with a room-temperature-curable silicone rubber composition that contains from 1 weight-ppm to 30 weight % of a triazole compound; and
thereafter curing the composition.

2. The method of protecting a transparent nonmetallic electroconductive part according to claim 1, wherein the transparent nonmetallic electroconductive part is formed by indium tin oxide (ITO).

3. The method of protecting a transparent nonmetallic electroconductive part according to claim 1, wherein the triazole compound is a 1,2,4-triazole compound or a benzotriazole compound.

4. The method of protecting a transparent nonmetallic electroconductive part according to claim 1, wherein the room-temperature-curable silicone rubber composition cures by an alcohol-eliminating, ketone-eliminating, or hydrogen-eliminating condensation reaction.

5. The method of protecting a transparent nonmetallic electroconductive part according to claim 4, wherein the room-temperature-curable silicone rubber composition that cures by an alcohol-eliminating condensation reaction comprises at least:
(A) 100 weight parts of an organopolysiloxane that has a viscosity at 25° C. of 20 to 1,000,000 mPa·s and that has in each molecule at least two silicon-bonded hydroxyl groups or silicon-bonded alkoxy groups;
(B) 0.5 to 15 weight parts of an alkoxysilane represented by the following general formula or the partial hydrolysis and condensation product of such an alkoxysilane
R¹ₐSi(OR²)₍₄₋ₐ₎
wherein R¹ is an unsubstituted or halogen-substituted monovalent hydrocarbyl group, R² is an alkyl group, and a is an integer from 0 to 2;
(C) a triazole compound at from 1 weight-ppm to 30 weight % in the present composition; and
(D) 0.1 to 10 weight parts of a condensation reaction catalyst.

6. The method of protecting a transparent nonmetallic electroconductive part according to claim 2, wherein the room-temperature-curable silicone rubber composition cures by an alcohol-eliminating, ketone-eliminating, or hydrogen-eliminating condensation reaction.

7. The method of protecting a transparent nonmetallic electroconductive part according to claim 3, wherein the room-temperature-curable silicone rubber composition cures by an alcohol-eliminating, ketone-eliminating, or hydrogen-eliminating condensation reaction.

8. The method of protecting a transparent nonmetallic electroconductive part according to claim 1, wherein the room-temperature-curable silicone rubber composition contains from 10 weight-ppm to 1 weight % of the triazole compound.

9. The method of protecting a transparent nonmetallic electroconductive part according to claim 1, wherein the transparent nonmetallic electroconductive part is formed by antimony-doped tin oxide (ATO).

10. The method of protecting a transparent nonmetallic electroconductive part according to claim 1, wherein the transparent nonmetallic electroconductive part is formed by zinc oxide (ZnO).
